(19) United States
(12) Patent Application Publication
(10) Pub. No.: US 2019/0100717 A1
(43) Pub. Date: Apr. 4, 2019

(54) STRUCTURING

(71) Applicant: The Procter & Gamble Company, Cincinnati, OH (US)

(72) Inventors: Walter August Maria BROECKX, Berlare (BE); Susana FERNANDEZ-PRIETO, Brussels (BE); Vincenzo GUIDA, Woluwe St. Pierre (BE)

(21) Appl. No.: 16/136,611

(22) Filed: Sep. 20, 2018

(30) Foreign Application Priority Data
Sep. 29, 2017 (EP) 17193935.8

(51) Int. Cl. C11D 17/00; C11D 3/30; C11D 3/382; C11D 3/20; C11D 1/22; C11D 11/00

(52) U.S. Cl. CPC C11D 17/0026; C11D 17/0013; C11D 3/30; C11D 11/0094; C11D 3/2079; C11D 1/22; C11D 3/382

(57) ABSTRACT

A process to prepare external structuring system(s) (ESS) comprising an acidified non-polymeric, crystalline, hydroxyl-containing structuring agent, the external structuring system, and compositions comprising them.

### FIELD OF THE INVENTION

Improved external structuring systems, comprising non-polymeric, crystalline, hydroxyl-containing structuring agent by increasing the acidity of the feedstock of the non-polymeric, crystalline, hydroxyl-containing structuring agent.

### BACKGROUND OF THE INVENTION

Structuring premixes comprising a non-polymeric, crystalline, hydroxyl-containing structuring agent, such as hydrogenated castor oil, have been used to structure and thicken liquid compositions. While the non-polymeric, crystalline, hydroxyl-containing structuring agent can be melted and directly dispersed into a liquid composition, the structuring agent is usually first formed into a premix in order to both improve processability, and to improve structuring efficacy. Hence, the molten structuring agent is generally first emulsified in water, and then crystallised to form a structuring premix. The resultant structuring premix is then added to a liquid composition (see for example, WO2011031940).

While such structuring premixes are highly effective at structuring and thickening liquid compositions, there remains a need to improve the efficacy of such structuring premixes.

WO2011120772A1 relates to a process for the incorporation of microcapsules with anionic charge into a structured aqueous concentrated liquid detergent comprising at least 30 wt %, preferably at most 65 wt %, total surfactant of which at least 5 wt % based on the total composition is anionic surfactant, including soap, and an external structurant, the process comprising the combining of two premixes; Premix A which is the structured aqueous concentrated liquid detergent composition without microcapsules and Premix B which comprises an aqueous dispersion of the microcapsules with anionic charge, characterised in that: Premix B is a slurry of microcapsules with a maximum viscosity at 25° C. of 100 mPa·s and at least 90 wt % of the microcapsules having a particle size in the range 5 to 30 microns, and that Premix B is added to Premix A and the resulting combined mixture is passed through a static in-line mixer with an energy input of from 20 to 500 J/kg to form, immediately after the mixer, a structured liquid comprising less than 10%, based on the total number of groups of microcapsules, agglomerated groups of microcapsules, an agglomerated group of microcapsules being defined as a group having more than 5 microcapsules grouped together. WO2010/34736A1 relates to phosphate free liquid detergent compositions and methods for production of liquid detergent compositions, wherein the hydrogenated castor oil crystallises on cooling from a premix of warm non-aqueous organic solvent to form a dendritic structure.

### SUMMARY OF THE INVENTION

The present invention relates to a process for preparing an external structuring system for liquid and gel-form detergents comprising steps of:
a) combining a structuring agent, wherein the structuring agent is a non-polymeric, crystalline, hydroxyl-containing structuring agent, and an acid at a temperature greater than the melting point of the structuring agent, to form an acidified structuring agent; and
b) preparing a premix by adding 5% to 50% by weight of the external structuring system of an anionic surfactant or a mixture thereof into water and mixing;
c) adding from 2% to 10% by weight of the external structuring system of the acidified structuring agent and mixing to form an emulsified, acidified structuring agent;
wherein either the premix of step b) or the mixture of step c) is heated to a temperature above the melting point of the structuring agent;
d) and cooling the emulsified, acidified structuring agent to a temperature of less than 40° C.

### DETAILED DESCRIPTION OF THE INVENTION

As used herein, the term “external structuring system” or ESS refers to a selected compound or mixture of compounds which provide structure to a detergent composition independently from, or extrinsic from, any structuring effect of the detersive surfactants of the composition. Structuring benefits include arriving at yield stresses suitable for suspending particles having a wide range of sizes and densities. ESS of use may have chemical identities set out in detail hereinafter.

The external structuring premixes are formed by the process of the present invention, whereby an acid is added to the structuring agent, which is a non-polymeric, crystalline, hydroxyl-containing structuring agent, to form an acidified structuring agent, before emulsifying the acidified structuring agent to form an emulsified, acidic structuring agent. The resultant external structuring premixes provides improved structuring.

“Liquid” as used herein may include liquids, gels, foams, mousse, and any other flowable substantially non-gas phased composition. Non-limiting examples of fluids within the scope of this invention include light duty and heavy duty liquid detergent compositions, hard surface cleaning compositions, detergent gels commonly used for laundry, and bleach and laundry additives. Gases, e.g., suspended bubbles, may be included within the liquids.

By “internal structuring” it is meant that the detergent surfactants, which form a major class of laundering ingredients, are relied on for structuring effect. The present invention, in the opposite sense, aims at “external structuring” meaning structuring which relies on a nonsurfactant, e.g., crystallized glyceride(s) including, but not limited to, hydrogenated castor oil, to achieve the desired rheology and particle suspending power.

“Limited solubility” as used herein means that no more than nine tenths of the formulated agent actually dissolves in the liquid composition. An advantage of crystallizable glyceride(s) such as hydrogenated castor oil as an external structurant is an extremely limited water solubility.

“Soluble” as used herein means that more than nine tenths of the formulated agent actually dissolves in the liquid composition at a temperature of 20° C.

ESS according to the present invention is also called a premix. “Premix” as used herein means a mixture of ingredients designed to be mixed with other ingredients, such as the balance of a liquid or gel-form laundry detergent, before marketing. A “premix” can itself be an article of commerce, and can be sold, for example in bulk containers, for later mixing with the balance of a laundry detergent at a remote location. One the other hand some premixes may directly be used for arriving at a complete detergent composition made in a single facility.

“Emulsion” as used herein, unless otherwise specifically indicated, refers to macroscopic droplets, which are large enough to be seen using conventional optical microscopy, of the non-polymeric, crystalline hydroxyl-containing structuring agent, in the structurant premix (ESS). The emulsion can involve liquid droplets or can involve solidified droplets, depending on the temperature. Hydrogenated castor oil is soluble to a limited extent in the alkanolamine neutralized anionic surfactant containing premix, and as a result, microemulsions may also be present.

All percentages, ratios and proportions used herein are by weight percent of the respective premix or composition, unless otherwise specified. All average values are calculated “by weight” of the respective premix, composition, or components thereof, unless otherwise expressly indicated.

Unless otherwise noted, all component, premix, or composition levels are in reference to the active portion of that component, premix, or composition, and are exclusive of impurities, for example, residual solvents or by-products, which may be present in commercially available sources of such components or compositions.

All measurements are performed at 25° C. unless otherwise specified.

### Process of Preparing External Structuring System:

The ESS can be prepared by using a process comprising the steps of:
a) combining a structuring agent, which is a non-polymeric, crystalline, hydroxyl-containing structuring agent, and an acid at a temperature greater than the melting point of the structuring agent, to form an acidified structuring agent; and
b) preparing a premix by adding 5% to 50% by weight of the external structuring system of an anionic surfactant or a mixture thereof into water and mixing;
c) adding from 2% to 10% by weight of the external structuring system of the acidified structuring agent and mixing to form an emulsified, acidified structuring agent;
wherein either the premix of step b) or the mixture of step c) is heated to a temperature above the melting point of the structuring agent;
d) and cooling the emulsified, acidified structuring agent to a temperature of less than 40° C.

The resultant external structuring system comprises:
a) from 2% to 10% by weight of the external structuring system of acidified structuring agent, wherein the acidified structuring agent comprises a non-polymeric, crystalline, hydroxyl-containing structuring agent and an acid;
b) from 5% to 50% by weight of the external structuring system of an anionic surfactant or a mixture thereof; and
c) water.

The process to make the emulsion can be a continuous process or a batch process. By being continuous, down-time between runs is reduced, resulting in a more cost and time efficient process. By ‘continuous process’ we herein mean continuous flow of the material through the apparatus. By ‘batch processes’ we herein mean where the process goes through discrete and different steps. The flow of product through the apparatus is interrupted as different stages of the transformation are completed, i.e. discontinuous flow of material.

Without being bound by theory, it is believed that the use of a continuous process provides improved control of the emulsion droplet size, as compared to a batch process. As a result, a continuous process typically results in more efficient production of droplets having the desired mean size, and hence a narrower range of droplet sizes. Batch production of the emulsion generally results in larger variation of the droplet size produced, due to the inherent variation in the degree of mixing occurring within the batch tank. Variability can arise due to the use and placement of the mixing paddle within the batch tank. The result is zones of slower moving liquid (and hence less mixing and larger droplets), and zones of faster moving liquid (and hence more mixing and smaller droplets). Those skilled in the art will know how to select appropriate mixing devices to enable a continuous process. Furthermore, a continuous process will allow for faster transfer of the emulsion to the cooling step. The continuous process will also allow for less premature cooling, that can occur in a batch tank before transfer to the cooling step.

Each of the steps and the ingredients are discussed below:

### Combining a Non-Polymeric, Crystalline, Hydroxyl-Containing Structuring Agent and an Acid:

In this step, a structuring agent, which is a non-polymeric, crystalline, hydroxyl-containing structuring agent, and an acid are combined at a temperature greater than the melting point of the structuring agent, to form an acidified structuring agent.

Non-polymeric, crystalline, hydroxyl-containing structuring agent(s) of use herein include “Hydrogenated castor oil” or “HCO” and is an essential component the ESS of the present invention. HCO as used herein most generally can be any hydrogenated castor oil, provided that it is capable of crystallizing in the ESS premix. Castor oils may include glycerides, especially triglycerides, comprising C10 to C22 alkyl or alkenyl moieties which incorporate a hydroxyl group. Hydrogenation of castor oil to make HCO converts double bonds, which may be present in the starting oil as ricinoleyl moieties, to convert ricinoleyl moieties to saturated hydroxyalkyl moieties, e.g., hydroxystearyl. The HCO herein may, in some embodiments, be selected from: trihydroxystearin; dihydroxystearin; and mixtures thereof. The HCO may be processed in any suitable starting form, including, but not limited those selected from solid, molten and mixtures thereof. HCO is present in the ESS of the present invention at a level of from 2% to 10%, from 3% to 8%, or from 4% to 6% by weight of the ESS. In some embodiments, the corresponding percentage of hydrogenated castor oil delivered into a finished laundry detergent product is below 1.0%, typically from 0.1% to 0.8%.

Useful HCO may have the following characteristics: a melting point of from 40° C. to 100° C., preferably from 65° C. to 95° C.; and/or Iodine value ranges of from 0 to 5, preferably from 0 to 4, and most preferably from 0 to 2.6. The melting point of HCO can be measured using either ASTM D3418 or ISO 11357; both tests utilize DSC: Differential Scanning calorimetry.

HCO of use in the present invention includes those that are commercially available. Non-limiting examples of commercially available HCO of use in the present invention include: THIXCIN® from Rheox, Inc. Further examples of useful HCO may be found in U.S. Pat. No. 5,340,390. The source of the castor oil for hydrogenation to form HCO can be of any suitable origin, such as from Brazil or India. In one suitable embodiment, castor oil is hydrogenated using a precious metal, e.g., palladium catalyst, and the hydrogenation temperature and pressure are controlled to optimize hydrogenation of the double bonds of the native castor oil while avoiding unacceptable

The invention is not intended to be directed only to the use of hydrogenated castor oil. Any other suitable non-polymeric, crystalline, hydroxyl-containing structuring agent(s), such as any suitable crystallizable glyceride(s) may be used. In one example, the structurant is substantially pure triglyceride of 12-hydroxystearic acid. This molecule represents the pure form of a fully hydrogenated triglyceride of 12-hydrox-9-cis-octadecenoic acid. In nature, the composition of castor oil is rather constant, but may vary somewhat. Likewise hydrogenation procedures may vary. Any other suitable equivalent materials, such as mixtures of triglycerides wherein at least 80% wt. is from castor oil, may be used. Exemplary equivalent materials comprise primarily, or consist essentially of, triglycerides; or comprise primarily, or consist essentially of, mixtures of diglycerides and triglycerides; or comprise primarily, or consist essentially of, mixtures of triglyerides with diglycerides and limited amounts, e.g., less than about 20% wt. of the glyceride mixtures, of monoglyerides; or comprise primarily, or consist essentially of, any of the foregoing glycerides with limited amounts, e.g., less than about 20% wt., of the corresponding acid hydrolysis product of any of said glycerides. A proviso in the above is that the major proportion, typically at least 80% wt, of any of said glycerides is preferably chemically identical to glyceride of fully hydrogenated ricinoleic acid, i.e., glyceride of 12-hydroxystearic acid. It is for example well known in the art to modify hydrogenated castor oil such that in a given triglyceride, there will be two 12-hydroxystearic-moieties and one stearic moiety. Likewise it is envisioned that the hydrogenated castor oil may not be fully hydrogenated.

The structuring agent is combined with an acid. The acid can be selected from the group consisting of: a carboxylic acid, such as a fatty acid, with a substituted or unsubstituted long aliphatic chain having at least 6, preferably at least 8 carbon chains in the backbone, which is either saturated or unsaturated, and mixtures thereof, preferably wherein the aliphatic chain comprises between 12 and 28 carbons atoms. The number of unsaturations is preferably less than 5, preferably less than 4 even more preferably less than 3. The fatty acid can be fully saturated. Preferable fatty acids are not branched, such as those which are naturally derived (derived from natural oils such as palm oil and the like).

The acid can be selected from the group consisting of arachidic acid, arachidonic acid, behenic acid, cerotic acid, eicosapentaenoic acid, elaidic acid, erucic acid, lauric acid, linoleic acid, linolenic acid, myristic acid, myristoleic acid, oleic acid, palmitic acid, palmitoleic acid, sapienic acid, stearic acid, vaccenic acid and mixtures thereof, preferably behenic acid, lauric acid, linoleic acid, linolenic acid, myristic acid, myristoleic acid, oleic acid, palmitic acid, palmitoleic acid, stearic acid and mixtures thereof, more preferably linoleic acid, stearic acid and mixtures thereof.

The acid can be combined with the structuring agent such that the structuring agent and an acid are present in a weight ratio of from 98:2 to 75:25, preferably from 96:4 to 80:20, more preferably from 95:5 to 89:11.

The acidified structuring agent can be immediately used in subsequent steps, for instance, in its melted form. Alternatively, the acidified structuring agent can be stored, for instance after cooling to a solid state, for use at a later date.

### Preparing a Surfactant Premix:

In this step, a surfactant premix is made. The surfactant premix is prepared by adding 5% to 50% by weight of the external structuring system of an anionic surfactant or a mixture thereof into water and mixing.

The premix comprises water and an anionic surfactant or a mixture thereof. The anionic surfactant is added to the water of the ESS and mixed. The premix can be heated, for instance to a temperature of 90° C. in order to reduce the time required for mixing. Preferably demineralised water is used.

Anionic surfactant is an essential component the ESS of the present invention. Without wishing to be bound by theory, it is believed that the anionic surfactant acts as an emulsifier of melts of HCO and other non-polymeric, crystalline, hydroxyl-containing structuring agent. In the context of the external structuring system only (as opposed to in the context of a liquid detergent composition comprising a surfactant system), the following is true. As used herein “anionic surfactant” in preferred embodiments does not include soaps and fatty acids; they may be present in the final laundry detergent compositions, but in general, other than limited amounts of 12-hydroxystearic acid which may arise from limited hydrolysis of hydrogenated castor oil glycerides, are not deliberately included in the ESS. For overall formula accounting purposes, “soaps” and “fatty acids” are accounted as builders.

Suitable anionic surfactants for use herein can comprise any of the conventional anionic surfactant types typically used in liquid products. These include the alkyl sulfonic acids, alkyl benzene sulfonic acids, ethoxylated alkyl sulfates and their salts.

Non-limiting examples of suitable anionic surfactants of use herein include: Linear Alkyl Benzene Sulphonate (LAS), Alkyl Sulphates (AS), Alkyl Ethoxylated Sulphonates (AES), Laureth Sulfates and mixtures thereof, most preferred anionic surfactant is liner alkyl benzene sulphonate (LAS). The anionic surfactant may be present in the external structuring system at a level of from 5% to 50%, preferably from 8 wt % to 29 wt % of the anionic surfactant. However, when using more than 25% by weight of the ESS of an anionic surfactant, it is typically required to thin the surfactant using an organic solvent.

Preferred anionic surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Preferred are the sodium and potassium linear alkylbenzene sulfonates in which the average number of carbon atoms in the alkyl group is from about 11 to 14. Most preferred are the acidic form of linear alkylbenzene sulfonates (HLAS) in which the average number of carbon atoms in the alkyl group is from about 11 to 14. C₁₁-C₁₄, e.g., C₁₂ HLAS is most preferred.

A pH adjusting agent or a mixture thereof can be added, preferably to set the pH from 7.0 to 8.0 at the temperature between 87° C. and 95° C. and mixing. The pH mentioned is the neat pH at the process temperature mentioned. It is desired to have pH neutral ESS, for improved structuring efficacy. Furthermore, pH neutral ESS is easier to add into final product as no neutralizing step is then required.

In general any known pH-adjusting agents are useful herein, including alkalinity sources as well

Inorganic alkalinity sources include but are not limited to, water-soluble alkali metal hydroxides, oxides, carbonates, bicarbonates, borates, silicates, metasilicates, and mixtures thereof; water-soluble alkali earth metal hydroxides, oxides, carbonates, bicarbonates, borates, silicates, metasilicates, and mixtures thereof; water-soluble boron group metal hydroxides, oxides, carbonates, bicarbonates, borates, silicates, metasilicates, and mixtures thereof; and mixtures thereof. Preferred inorganic alkalinity sources are sodium hydroxide, and potassium hydroxide and mixtures thereof, most preferably inorganic alkalinity source is sodium hydroxide. Although not preferred for ecological reasons, water-soluble phosphate salts may be utilized as alkalinity sources, including pyrophosphates, orthophosphates, polyphosphates, phosphonates, and

Organic alkalinity sources include but are not limited to, primary, secondary, tertiary amines, and mixtures thereof.

Other organic alkalinity sources are alkanolamine or mixture of alkanolamines. Suitable alkanolamines may be selected from the lower alkanol mono-, di-, and trialkanolamines, such as monoethanolamine; diethanolamine or triethanolamine. Higher alkanolamines have higher molecular weight and may be less mass efficient for the present purposes. Mono- and dialkanolamines are preferred for mass efficiency reasons. Monoethanolamine is particularly preferred, however an additional alkanolamine, such as triethanolamine, can be useful in certain embodiments as a buffer. Most preferred alkanolamine used herein is monoethanol amine.

Inorganic acidifying agents include but are not limited to, HF, HCl, HBr, HI, boric acid, phosphoric acid, phosphonic acid, sulphuric acid, sulphonic acid, and mixtures thereof. Preferred inorganic acidifying agent is boric acid.

Organic acidifying agents include but are not limited to, substituted and substituted, branched, linear and/or cyclic C₁ to C₃₀ carboxyl acids, and mixtures thereof.

The pH adjusting agent can be selected from group consisting of monoethanolamine, diethanolamine, triethanolamine, sodium hydroxide and mixtures thereof, most preferably pH adjusting agent is monoethanolamine. The pH adjusting agent is used at level from 2% to 10% by weight of the external structuring system.

The surfactant premix can be heated to a temperature above the melting point of the structuring agent, in order to emulsify the acidified structuring agent. Alternatively, after the addition of the acidified structuring agent, the mixture can be heated to a temperature above the melting point of the non-polymeric, crystalline, hydroxyl-containing structuring agent, for emulsification to proceed.

### Adding the Acidified Structuring Agent to the Surfactant Premix:

From 2% to 10% by weight of the external structuring system of acidified structuring agent is added to the surfactant premix, under agitation, to form an emulsified, acidified structuring agent.

The acidified structuring agent can be added in melted form. Alternatively, the acidified structuring agent can be added as a solid, for instance as flakes, and melted by heating the mixture of the acidified structuring agent and surfactant premix.

The temperature may be increased using heat of neutralization of the anionic surfactant acid from mixing with the pH adjusting agent; and/or through the application of heat from an external source.

The mixture can be heated to a temperature above room temperature. The mixture is preferably heated to above the melting point of the crystallizable glyceride, such as HCO for example. In some embodiments, the mixture is heated to a temperature of from 50° C. to 150° C., or from 75° C. to 125° C., or from 80° C. to 95° C.

The acidified structuring agent is emulsified, forming an emulsion, a mixture of an emulsion and a microemulsion, or a microemulsion by mixing with medium to high agitator speed. Emulsification may be also accomplished by increasing the temperature of the premix and/or by energy dissipation through the premix.

With energy dissipation, it is understood that any kind of device, delivering energy input to the premix can be applied to form the emulsion. Non-limiting examples of such devices may be selected from: static mixers and dynamic mixers (including all kinds of low shear and high shear mixers). In some embodiments, the emulsion can be formed in batch making system or in a semi continuous making system or a continuous making system.

Depending on the pH of the surfactant premix, the acidified structuring agent can be neutralized upon addition to the surfactant premix. Hence, the emulsified, acidified structuring agent has a pH which is typically neutral or alkaline, since the pH of the surfactant premix is typically neutral or alkaline.

### Cooling the Emulsion:

In this step, the emulsion is then cooled. Without wishing to be bound by theory, it is believed that during cooling, the liquid oil emulsion droplets de-wet as a result of surfactant adsorption, thereby promoting crystallization. Small crystals may nucleate from around the emulsion droplets during cooling. It is further believed that crystallization may be influenced by surfactant adsorption and/or cooling rate.

Preferably the external structuring system is cooled at a cooling rate of from 1° C./min to 2° C./min.

### Optional Additional Components of the External Structuring System:

The ESS may optionally contain surfactant in addition to anionic surfactants. In some embodiments, the systems may further comprise surfactant selected from: nonionic surfactant; cationic surfactant; amphoteric surfactant; zwitterionic surfactant; and mixtures thereof.

The ESS may optionally contain a pH buffer. Without wishing to be bound by theory, it is believed that the buffer stabilizes the pH of the ESS thereby limiting any potential hydrolysis of non-polymeric, crystalline, hydroxyl-containing structuring agents such as HCO structurant. However, buffer-free embodiments can be contemplated and when HCO hydrolyses, some 12-hydroxystearate may be formed, which has been described in the art as being capable of structuring. In certain preferred buffer-containing embodiments, the pH buffer does not introduce monovalent inorganic cations, such as sodium, in the structuring system. In some embodiments, the preferred buffer is the monethanolamine salt of boric acid. However embodiments are also contemplated in which the buffer is sodium-free and boron-free; or is free from any deliberately added sodium, boron or phosphorus. In some embodiments, the MEA neutralized boric acid may be present at a level of from 0% to 5%, from 0.5% to 3%, or from 0.75% to 1% by weight of the structuring system.

Alkanolamines such as triethanolamine and/or other amines can be used as buffers; provided that alkanolamine is first provided in an amount sufficient for the primary structurant emulsifying purpose of neutralizing the acid form of anionic surfactants.

The ESS contains water. Water may form the balance of the present structuring systems after the weight percentage of all of the other ingredients are taken into account.

The water may be present at a level of from 5% to 90% by weight of the external structuring system, preferably from 10% to 80%, more preferably from 15% to 78% and most preferably from 30% to 78%.

Preservatives such as soluble preservatives may be added to the ESS or to the final detergent product so as to limit contamination by microorganisms. Such contamination can lead to colonies of bacteria and fungi capable of resulting in phase separation, unpleasant, e.g., rancid odors and the like. The use of a broad-spectrum preservative, which controls the growth of bacteria and fungi is preferred. Limited-spectrum preservatives, which are only effective on a single group of microorganisms may also be used, either in combination with a broad-spectrum material or in a “package” of limited-spectrum preservatives with additive activities. Depending on the circumstances of manufacturing and consumer use, it may also be desirable to use more than one broad-spectrum preservative to minimize the effects of any potential contamination.

Preferred preservatives for the compositions of this invention include organic sulphur compounds, halogenated materials, cyclic organic nitrogen compounds, low molecular weight aldehydes, quaternary ammonium materials, dehydroacetic acid, phenyl and phenoxy

Examples of preferred preservatives for use in the compositions of the present invention include: a mixture of 77% 5-chloro-2-methyl-4-isothiazolin-3-one and 23% 2-methyl-4-isothiazolin-3-one, which is sold commercially as a 1.5% aqueous solution by Rohm & Haas (Philadelphia, Pa.) under the trade name Kathon; 1,2-benzisothiazolin-3-one, which is sold commercially by Avecia (Wilmington, Del.) as, for example, a 20% solution in dipropylene glycol sold under the trade name Proxel™ GXL sold by Arch Chemicals (Atlanta, Ga.); and a 95:5 mixture of 1,3 bis(hydroxymethyl)-5,5-dimethyl-2,4 imidazolidinedione and 3-butyl-2-iodopropynyl carbamate, which can be obtained, for example, as Glydant Plus from Lonza (Fair Lawn, N.J.). A highly preferred preservative system is sold commercially as Acticide™ MBS and comprises the actives methyl-4-isothiazoline (MIT) and 1,2-benzisothizolin-3-one (BIT) in approximately equal proportions by weight and at a total concentration in the Acticide™ MBS of 5%. The Acticide is formulated at levels of 0.001 to 0.1%, more typically 0.01 to 0.1% by weight on a 100% active basis in the ESS premix.

The ESS may comprise other thickeners in addition to the non-polymeric, crystalline, hydroxyl-containing structuring agent. Polymeric thickeners known in the art, e.g., Carbopol™ from Lubrizol (Wickliffe, Ohio), acrylate copolymers such as those known as associative thickeners and the like may be used to supplement the ESS. These materials may be added either in the ESS premix, or separately into the final detergent composition. Additionally or alternatively known LMOG (low molecular weight organogellants) such as dibenzylidene sorbitol may be added to the compositions either in the ESS premix, or in the final detergent compositions. Suitable use levels are from 0.01% to 5%, or from 0.1 to 1% by weight of the final detergent composition.

Either the ESS or the final detergent composition may further include particulate material such as suds suppressors, encapsulated sensitive ingredients, e.g., perfumes, bleaches and enzymes in encapsulated form; or aesthetic adjuncts such as pearlescent agents, pigment particles, mica or the like. Suitable use levels are from 0.0001% to 5%, or from 0.1% to 1% by weight of the final detergent composition. In embodiments of the invention it is found useful to incorporate certain particulate materials, e.g., mica for visual appearance benefits, directly into the ESS while formulating more sensitive particulate materials, e.g., encapsulated enzymes and/or bleaches, at a later point into the final detergent composition.

### General Shear Conditions:

The ESS herein can be manufactured using a range of equipment types and shear regimes. In one preferred embodiment, the process employs a relatively low shear regime, in which shear rates reach a maximum of from 100 to 500 s⁻¹, and the ESS experiences this shear maximum for a residence time under the highest shear condition of no more than 60 to 100 seconds (s). In practical terms, one process employs batch, pipe, pump and plate heat exchanger devices, and the maximum shear occurs in the plate heat exchanger stage used to cool the ESS; but the ESS passes quite seldom through this high shear area, for example only from about three to about five passes per production run.

### Liquid Compositions Comprising the Structuring Premix:

The structuring premix made by the process of the present invention, is useful for structuring liquid compositions. Suitable structured liquid compositions include liquid laundry detergent compositions comprising the external structuring system, and a detersive surfactant. The liquid compositions can comprise from 0.01 wt % to 2 wt %, preferably from 0.03 wt % to 1 wt %, more preferably from 0.05 wt % to 0.5 wt % of the non-polymeric, crystalline, hydroxyl-containing structuring agent, introduced via the structuring premix.

Suitable liquid compositions include: products for treating fabrics, including laundry detergent compositions and rinse additives; hard surface cleaners including dishwashing compositions, floor cleaners, and toilet bowl cleaners. The structuring premix of the present invention is particularly suited for liquid detergent compositions. Such liquid detergent compositions comprise sufficient detersive surfactant, so as to provide a noticeable cleaning benefit. Most preferred are liquid laundry detergent compositions, which are capable of cleaning a fabric, such as in a domestic washing machine.

As used herein, “liquid composition” refers to any composition comprising a liquid capable of wetting and treating a substrate, such as fabric or hard surface. Liquid compositions are more readily dispersible, and can more uniformly coat the surface to be treated, without the need to first dissolve the composition, as is the case with solid compositions. Liquid compositions can flow at 25° C., and include compositions that have an almost water like viscosity, but also include “gel” compositions that flow slowly and hold their shape for several seconds or even minutes.

A suitable liquid composition can include solids or gases in suitably subdivided form, but the overall composition excludes product forms which are non-liquid overall, such as tablets or granules. The liquid compositions preferably have densities in the range from of 0.9 to 1.3 grams per cubic centimetre, more preferably from 1.00 to 1.10 grams per cubic centimetre, excluding any solid additives but including any bubbles, if present.

Preferably, the liquid composition comprises from 1% to 95% by weight of water, non-aminofunctional organic solvent, and mixtures thereof. For concentrated liquid compositions, the composition preferably comprises from 15% to 70%, more preferably from 20% to 50%, most preferably from 25% to 45% by weight of water, non-aminofunctional organic solvent, and mixtures thereof. Alternatively, the liquid composition may be a low water liquid composition. Such low water liquid compositions can comprise less than 20%, preferably less than 15%, more preferably less than 10% by weight of water.

The liquid composition of the present invention may comprise from 2% to 40%, more preferably from 5% to 25% by weight of a non-aminofunctional organic solvent.

The liquid composition can also be encapsulated in a water soluble film, to form a unit dose article. Such unit dose articles comprise a liquid composition of the present invention, wherein the liquid composition is a low water liquid composition, and the liquid composition is enclosed in a water-soluble or dispersible film.

The unit dose article may comprise one compartment, formed by the water-soluble film which fully encloses at least one inner volume, the inner volume comprising the low water liquid composition. The unit dose article may optionally comprise additional compartments comprising further low water liquid compositions, or solid compositions. A multi-compartment unit dose form may be desirable for such reasons as: separating chemically incompatible ingredients; or where it is desirable for a portion of the ingredients to be released into the wash earlier or later. The unit-dose articles can be formed using any means known in the art.

Unit dose articles, wherein the low water liquid composition is a liquid laundry detergent composition are particularly preferred.

Suitable water soluble pouch materials include polymers, copolymers or derivatives thereof. Preferred polymers, copolymers or derivatives thereof are selected from the group consisting of: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

As mentioned earlier, the liquid composition can be a liquid detergent composition, preferably a liquid laundry detergent composition. Liquid detergent compositions comprise a surfactant, to provide a detergency benefit. The liquid detergent compositions of the present invention may comprise from 1% to 70%, preferably from 5% to 60%, more preferably from 10% to 50%, most preferably from 15% to 45% by weight of a detersive surfactant. Suitable detersive surfactants can be selected from the group consisting of: anionic, nonionic surfactants and mixtures thereof. The preferred weight ratio of anionic to nonionic surfactant is from 100:0 (i.e. no nonionic surfactant) to 5:95, more preferably from 99:1 to 1:4, most preferably from 5:1 to 1.5:1.

The liquid detergent compositions preferably comprise from 1 to 50%, more preferably from 5 to 40%, most preferably from 10 to 30% by weight of one or more anionic surfactants. Preferred anionic surfactant are selected from the group consisting of: C₁₁₋₁₈ alkyl benzene sulphonates, C₁₀₋₂₀ branched-chain and random alkyl sulphates, C₁₀₋₁₈ alkyl ethoxy sulphates, mid-chain branched alkyl sulphates, mid-chain branched alkyl alkoxy sulphates, C₁₀₋₁₈ alkyl alkoxy carboxylates comprising 1-5 ethoxy units, modified alkylbenzene sulphonate, C₁₂₋₂₀ methyl ester sulphonate, C₁₀₋₁₈ alpha-olefin sulphonate, C₆₋₂₀ sulphosuccinates, and mixtures thereof. However, by nature, every anionic surfactant known in the art of detergent compositions may be used, such as those disclosed in “Surfactant Science Series”, Vol. 7, edited by W. M. Linfield, Marcel Dekker. The detergent compositions preferably comprise at least one sulphonic acid surfactant, such as a linear alkyl benzene sulphonic acid, or the water-soluble salt form of the acid.

The detergent compositions preferably comprise up to 30%, more preferably from 1 to 15%, most preferably from 2 to 10% by weight of one or more nonionic surfactants. Suitable nonionic surfactants include, but are not limited to C₁₂₋₁₈ alkyl ethoxylates (“AE”) including the so-called narrow peaked alkyl ethoxylates, C₆₋₁₂ alkyl phenol alkoxylates (especially ethoxylates and mixed ethoxy/propoxy), block alkylene oxide condensate of C₆₋₁₂ alkyl phenols, alkylene oxide condensates of C₈₋₂₂ alkanols and ethylene oxide/propylene oxide block polymers (Pluronic® BASF Corp.), as well as semi polar nonionics (e.g., amine oxides and phosphine oxides). An extensive disclosure of suitable nonionic surfactants can be found in U.S. Pat. No. 3,929,678.

The liquid detergent composition may also include conventional detergent ingredients selected from the group consisting of: additional surfactants selected from amphoteric, zwitterionic, cationic surfactant, and mixtures thereof; enzymes; enzyme stabilizers; amphiphilic alkoxylated grease cleaning polymers; clay soil cleaning polymers; soil release polymers; soil suspending polymers; bleaching systems; optical brighteners; hueing dyes; particulates; perfume and other odour control agents, including perfume delivery systems; hydrotropes; suds suppressors; fabric care perfumes; pH adjusting agents; dye transfer inhibiting agents; preservatives; non-fabric substantive dyes; and mixtures thereof.

The structuring premixes of the present invention are particularly effective at stabilizing particulates since the structuring premix, comprising longer threads, provides improved low shear viscosity. As such, the structuring premixes of the present invention are particularly suited for stabilizing liquid compositions which further comprise particulates. Suitable particulates can be selected from the group consisting of microcapsules, oils, silicones, and mixtures thereof. Particularly preferred oils are perfumes, which provide an odour benefit to the liquid composition, or to substrates treated with the liquid composition. When added, such perfumes are added at a level of from 0.1% to 5%, more preferably from 0.3% to 3%, even more preferably from 0.6% to 2% by weight of the liquid composition. The structuring premixes of the present invention are also particularly suitable for improving the phase stability of compositions comprising polymers, such as soil release polymers and soil suspension polymers.

Microcapsules are typically added to liquid compositions, in order to provide a long lasting in-use benefit to the treated substrate. Microcapsules can be added at a level of from 0.01% to 10%, more preferably from 0.1% to 2%, even more preferably from 0.15% to 0.75% of the encapsulated active, by weight of the liquid composition. In a preferred embodiment, the microcapsules are perfume microcapsules, in which the encapsulated active is a perfume. Such perfume microcapsules release the encapsulated perfume upon breakage, for instance, when the treated substrate is rubbed.

The perfume microcapsules can be formed by surrounding a perfume with a wall material. The microcapsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol and mixtures thereof. Suitable melamine wall material can comprise melamine crosslinked with formaldehyde, melamine-dimethoxyethanol crosslinked with formaldehyde, and mixtures thereof, preferably formaldehyde. Suitable polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof. Suitable polyacrylate ester based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof. Suitable polystyrene wall material may comprise polyestyrene cross-linked with divinylbenzene. Suitable polyurea wall material may comprise urea crosslinked with formaldehyde, urea crosslinked with gluteraldehyde, and mixtures thereof. Polyurea based wall material may comprise a polyisocyanate, such as an aromatic polyisocyanate containing a phenyl, a toluoyl, a xylyl, a naphthyl or a diphenyl moiety (e.g., a polyisocyanurate of toluene diisocyanate, a trimethylol propane-adduct of toluene diisocyanate or a trimethylol propane-adduct of xylylene, diisocyanate), an aliphatic polyisocyanate (e.g., a trimer of hexamethylene diisocyanate, a trimer of isophorone diisocyanate and a biuret of hexamethylene diisocyanate), or a mixture thereof (e.g., a mixture of a biuret of hexamethylene diisocyanate and a trimethylol propane-adduct of xylylene diisocyanate). The polyisocyante may be cross-linked, the cross-linking agent being a polyamine (e.g., diethylenetriamine, bis(3-aminopropyl)amine, bis(hexanethylene)triamine, tris(2-aminoethyl)amine, triethylenetetramine, N,N′-bis(3-aminopropyl)-1,3-propanediamine, tetraethylenepentamine, pentaethylenehexamine, branched polyethylenimine, chitosan, nisin, gelatin, 1,3-diaminoguanidine monohydrochloride, 1,1-dimethylbiguanide hydrochloride, or guanidine carbonate).

The perfume microcapsule can be coated with a deposition aid. Suitable polymer deposition aids can be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, and combinations thereof.

The microcapsule core may optionally comprise a diluent. Diluents are material used to dilute the benefit agent that is to be encapsulated, and are hence preferably inert. That is, the diluent does not react with the benefit agent during making or use. Preferred diluents may be selected from the group consisting of: isopropylmyristate, propylene glycol, poly(ethylene glycol), or mixtures thereof.

Microcapsules, and methods of making them are disclosed in the following references: US 2003-215417 A1; US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. Nos. 6,645,479; 6,200,949; 4,882,220; 4,917,920; 4,514,461; US RE 32713; U.S. Pat. No. 4,234,627.

Encapsulation techniques are disclosed in MICROENCAPSULATION: Methods and Industrial Applications, Edited by Benita and Simon (Marcel Dekker, Inc., 1996). Formaldehyde based resins such as melamine-formaldehyde or urea-formaldehyde resins are especially attractive for perfume encapsulation due to their wide availability and reasonable cost.

The microcapsules preferably have a size of from 1 micron to 75 microns, more preferably from 5 microns to 30 microns. The microcapsule walls preferably have a thickness of from 0.05 microns to 10 microns, more preferably from 0.05 microns to 1 micron. Typically, the microcapsule core comprises from 50% to 95% by weight of the benefit agent.

### Methods:

### A) pH Measurement:

The pH is measured on the neat composition, at 21° C., using a pH meter with compatible gel-filled pH probe (such as Sartarius PT-10P meter with Toledo probe part number 52 000 100), calibrated according to the instructions manual.

### B) Method for Determining Dynamic Yield Stress and Viscosity:

Dynamic yield stress and viscosity are measured using a controlled stress rheometer (such as an HAAKE MARS from Thermo Scientific, or equivalent), using a 60 mm 1° C. one and a gap size of 52 microns at 20° C. The Dynamic yield stress is preferably measured on the composition before the addition of any particles, such as perfume microcapsules and the like. Where particles are present, a 60 mm plate-plate geometry should be used, with a gap size of 1000 microns.

The dynamic yield stress is obtained by measuring quasi steady state shear stress as a function of shear rate starting from 10 s⁻¹ to 10⁻⁴ s⁻¹, taking 25 points logarithmically distributed over the shear rate range. Quasi-steady state is defined as the shear stress value once variation of shear stress over time is less than 3%, after at least 30 seconds and a maximum of 60 seconds at a given shear rate. Variation of shear stress over time is continuously evaluated by comparison of the average shear stress measured over periods of 3 seconds. If after 60 seconds measurement at a certain shear rate, the shear stress value varies more than 3%, the final shear stress measurement is defined as the quasi state value for calculation purposes. Shear stress data is then fitted using least squares method in logarithmic space as a function of shear rate following a Herschel-Bulkley model:

σ=τ₀+k\dot{γ}ⁿ

wherein τ is the measured equilibrium quasi steady state shear stress at each applied shear rate \dot{γ}, τ₀ is the fitted dynamic yield stress. k and n are fitting parameters.

### C) Acid Value (AV)

The acid value number is the mass of potassium hydroxide (KOH) in milligrams required to neutralize each gram of the sample tested. This method measures the amount of carboxylic acid groups present in the sample. 3 gr of acidified or non-acidified non-polymeric, crystalline, hydroxyl-containing structuring agent (depending on whether the acid value is being measured for the acidified or non-acidified non-polymeric, crystalline, hydroxyl-containing structuring agent) are dissolved in 30 mL of ethanol. Then, a titration is performed with potassium hydroxide (KOH) using phenolphthalein as indicator. Automatic titrators such as Metrohm Titrando 809 are suitable to determine the acid value. Acid value can be obtained as follows:

$$AV = {V}_{KOH} {N}_{KOH} \frac{{M}_{wKOH}}{{W}_{HCO}}$$

wherein:
AV is the acid value expressed in mg KOH per gram of sample
V_{KOH} is the volume in mL of KOH needed to neutralize the sample.
N_{KOH} is the normality in mol/L of KOH used.
W_{HCO} is the amount of the acidified or non-acidified non-polymeric, crystalline, hydroxyl-containing structuring agent sample in grams
M_{wKOH} is the molecular weight of KOH in g/mol (56.1 g/mol).

### Examples

The external structurant premix were prepared as follows:

In a stress controlled rheometer (TA Discovery HR1 instrument with a Rheo-Reactor N. 1 geometry), 24 g linear alkylbenzene sulphonic acid (HLAS) was diluted into 115.2 g of demineralized water and then neutralized using 4.8 g of monoethanolamine (MEA), at 20-30° C., such that the surfactant solution has a pH of 8. The solution is heated to 95° C. and hydrogenated castor oil (melted with the fatty acid in a close container at 105° C.) was added under agitation at a shear rate of 50 s⁻¹, for 30 minutes. The mixture was then cooled down to 20° C. using a controlled cooling ramp of 0.5° C./min and controlled mixing at a shear rate of 50 s⁻¹. Preservative (Acticide MBS, Thor GmbH, Germany) was added and the mixture further mixed for 5 minutes at a shear rate of 50 s⁻¹.

| Premix composition | ESS A* | ESS 1 | ESS 2 | ESS 3 | ESS 4 | ESS 5 | ESS 6 | ESS 7 | ESS 8 |
|---|---|---|---|---|---|---|---|---|---|
| ingredients | % wt | % wt | % wt | % wt | % wt | % wt | % wt | % wt | % wt |
| HLAS¹ | 16 | 16 | 16 | 16 | 16 | 16 | 16 | 16 | 16 |
| Monoethanolamine | 3.2 | 3.2 | 3.2 | 3.2 | 3.2 | 3.2 | 3.2 | 3.2 | 3.2 |
| Hydrogenated castor oil | 4 | 4 | 4 | 4 | 4 | 4 | 4 | 4 | 4 |
| Oleic acid | — | — | — | 0.4 | 0.8 | — | — | — | — |
| Linoleic acid | — | — | — | — | — | 0.4 | 0.8 | — | — |
| Stearic acid | — | 0.4 | 0.8 | — | — | — | — | — | — |
| Palmitic acid | — | — | — | — | — | — | — | 0.4 | 0.8 |
| Acid value of acidified | 1.58 | 20.15 | 34.28 | 19.79 | 35.15 | 20.24 | 34.73 | 22.02 | 36.53 |
| hydrogenated castor oil | | | | | | | | | |
| (mgKOH/g) | | | | | | | | | |

*comparative example
¹C₁₁₋₁₄ alkyl benzene sulfonic acid

The external structuring premixes were formulated into a liquid laundry composition comprising 10 wt % of linear alkylbenzene sulphonic acid, 2.0 wt % of monoethanolamine, and the balance water, to provide a level of 0.25% of hydrogenated castor oil in the composition.

The dynamic yield stress of resulting compositions was measured and is provided in the table below.

| Liquid laundry | Dynamic Yield stress in model |
|---|---|
| composition | composition A at 0.25% HCO |
| comprising ESS: | (Pa) |
| A* | 0.031 |
| 1 | 0.181 |
| 2 | 0.052 |
| 3 | 0.044 |
| 4 | 0.075 |
| 5 | 0.108 |
| 6 | 0.052 |
| 7 | 0.043 |
| 8 | 0.074 |

In all cases the addition of the acid to the non-polymeric, crystalline, hydroxyl-containing structuring agent (HCO) before emulsification improved the structuring efficacy of the external structuring system, as can be seen from the dynamic yield stress of the resultant liquid laundry compositions.

Liquid detergent compositions comprising external structuring premix made using the process of the present invention:

| | Composition A | Composition B |
|---|---|---|
| Ingredient | wt % | wt % |
| HLAS³ | 7.5 | 10.5 |
| C12-14 alkyl ethoxy 3 sulfate Na salt | 2.6 | — |
| C12-14 alkyl ethoxy 3 sulfate MEA salt | — | 8.5 |
| C12-14 alkyl 7-ethoxylate | 0.4 | 7.6 |
| C14-15 alkyl 7-ethoxylate | 4.4 | — |
| C12-18 Fatty acid | 3.1 | 8 |
| Sodium Cumene sulfonate | 0.9 | |
| Citric acid | 3.2 | 2.8 |
| Ethoxysulfated Hexamethylene Diamine | 1 | 2.1 |
| Dimethyl Quat | | |
| Soil Suspending Alkoxylated | 0.4 | — |
| Polyalkylenimine Polymer⁴ | | |
| PEG-PVAc Polymer⁵ | 0.5 | 0.8 |
| Di Ethylene Triamine Penta (Methylene | 0.3 | |
| Phosphonic acid, Na salt) | | |
| Hydroxyethane diphosphonic acid | — | 1.5 |
| Fluorescent Whitening Agent | 0.1 | 0.3 |
| 1,2 Propanediol | 3.9 | 7.5 |
| Diethylene Glycol | | 3.5 |
| Sodium Formate | 0.4 | 0.4 |
| ESS 1 | 3.2 | 7.5 |
| Perfume | 0.9 | 1.7 |
| Sodium Hydroxide | To pH 8.4 | — |
| Monoethanolamine | 0.3 | To pH 8.1 |
| Protease enzyme | 0.4 | 0.7 |
| Amylase enzyme | — | 0.7 |
| Mannanase enzyme | 0.1 | 0.2 |
| Xyloglucanase enzyme | — | 0.1 |
| Pectate lyase | 0.1 | — |

| | |
|---|---|
| Water and minors (antifoam, | To 100 parts |
| aesthetics, . . . ) | |

³Weight percentage of Linear Alkylbenzene sulfonic acid includes that which added to the composition via the premix
⁴600 g/mol molecular weight polyethylenimine core with 20 ethoxylate groups per —NH.
⁵PEG-PVA graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.

Multicompartment unit dose articles comprising liquid compositions, wherein the liquid compositions comprise external structuring systems made by the process of the present invention. The liquid compositions are enclosed within polyvinyl alcohol (PVA) film, in order to form the unit dose articles. The PVA film used in the present examples is Monosol M8630 76 μm thickness:

| | Article A | | | Article B | | Article C | | |
|---|---|---|---|---|---|---|---|---|
| | Compartment | | | | | | | |
| | 1 | 2 | 3 | 1 | 2 | 1 | 2 | 3 |
| | Dosage in compartment (g) | | | | | | | |
| | 34 | 3.5 | 3.5 | 30 | 5 | 25 | 1.5 | 4 |
| Ingredients | wt % | wt % | wt % | wt % | wt % | wt % | wt % | wt % |
| HLAS¹ | 20 | 20 | 20 | 10 | 20 | 20 | 25 | 30 |
| C₁₂₋₁₄ sodium alkyl sulfate | — | — | — | 2 | — | — | — | — |
| C₁₂₋₁₄ alkyl 7-ethoxylate | 17 | 17 | 17 | — | 17 | 17 | 15 | 10 |
| C₁₂₋₁₄ alkyl 3-ethoxy sulfate | 7.5 | 7.5 | 7.5 | — | — | 7.5 | 7.5 | — |
| Citric acid | 0.5 | — | 2 | 1 | — | — | — | 2 |
| C₁₂₋₁₈ Fatty acid | 13 | 13 | 13 | | 18 | 18 | 10 | 15 |
| Sodium citrate | — | — | — | 4 | 2.5 | — | — | — |
| Enzymes | 0-3 | 0-3 | 0-3 | 0-3 | | 0-3 | 0-3 | 0-3 |
| Ethoxylated Polyethylenimine⁶ | 2.2 | 2.2 | 2.2 | — | — | — | — | — |
| Hydroxyethane diphosphonic acid | 0.6 | 0.6 | 0.6 | 0.5 | — | — | 2.2 | — |
| DTPMP⁷ | — | — | — | — | — | 0.4 | — | — |
| Brightener | 0.2 | 0.2 | 0.2 | 0.3 | — | 0.3 | | |
| Water | 9 | 8.5 | 10 | 5 | 11 | 10 | 10 | 9 |
| CaCl2 | — | — | — | — | — | — | 0.01 | — |
| Perfume | 1.7 | 1.7 | — | 0.6 | — | 1.5 | 0.5 | — |
| Perfume Capsules | 2.5 | | | 1.4 | | 0.5 | 5 | — |
| Minors (antioxidant, sulfite, | 2 | 2 | 2 | 4 | 1.5 | 2.2 | 2.2 | 2 |
| aesthetics, . . .) | | | | | | | | |
| Premix 1 | 2 | — | — | — | — | 2 | 4 | — |
| Premix 5 | — | — | — | 1.75 | — | — | — | — |
| Sodium hydroxide | pH | pH | pH | pH | pH | pH | pH | pH |
| | 8.0 | 8.0 | 8.0 | 8.0 | 8.0 | 8.0 | 8.0 | 8.0 |
| Solvents (1,2 propanediol, | to | to | to | to | to | to | to | to |
| ethanol) | 100% | 100% | 100% | 100% | 100% | 100% | 100% | 100% |

⁶Polyethyleneimine (MW = 600) with 20 ethoxylate groups per —NH, supplied by BASF
⁷Ethylene diamine tetra(methylene phosphonic) acid

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for preparing an external structuring system for liquid and gel-form detergents comprising the steps of:
a) combining a structuring agent, wherein the structuring agent is a non-polymeric, crystalline, hydroxyl-containing structuring agent, and an acid at a temperature greater than the melting point of the structuring agent, to form an acidified structuring agent; and
b) preparing a premix by adding about 5% to about 50% by weight of the external structuring system of an anionic surfactant or a mixture thereof into water and mixing;
c) adding from about 2% to about 10% by weight of the external structuring system of the acidified structuring agent to the premix and mixing to form an emulsified, acidified structuring agent;
wherein either the premix of step b) or the mixture of step c) is heated to a temperature above the melting point of the non-polymeric, crystalline, hydroxyl-containing structuring agent;
d) and cooling the emulsified, acidified structuring agent to a temperature of less than about 40° C. to form the external structuring system.

2. The process according to claim 1, wherein the non-polymeric, crystalline, hydroxyl-containing structuring agent comprises hydrogenated castor oil or derivatives thereof.

3. The process according to claim 1, wherein in step a), the non-polymeric, crystalline, hydroxyl-containing structuring agent is added to provide a level of from about 2.0 wt % to about 10.0 wt % of the external structuring system.

4. The process according to claim 1, wherein in step a), the acid is selected from the group consisting of: a carboxylic acid with a substituted or unsubstituted long aliphatic chain having at least 6 carbon chains in the backbone, which is either saturated or unsaturated, and mixtures thereof, wherein the aliphatic chain comprises between 12 and 28 carbons atoms.

5. The process according to claim 4, wherein in step a), the acid is selected from the group consisting of arachidic acid, arachidonic acid, behenic acid, cerotic acid, eicosapentaenoic acid, elaidic acid, erucic acid, lauric acid, linoleic acid, linolenic acid, myristic acid, myristoleic acid, oleic acid, palmitic acid, palmitoleic acid, sapienic acid, stearic acid, vaccenic acid and mixtures thereof.

6. The process according to claim 1, wherein in step a), the non-polymeric, crystalline, hydroxyl-containing structuring agent and an acid are present in a weight ratio of from about 98:2 to about 75:25.

7. The process according to claim 1, wherein in step b), the anionic surfactant is a synthetic anionic surfactant selected from the group consisting of sodium and potassium linear alkylbenzene sulfonates and acidic form of linear alkylbenzene sulfonates (HLAS), in which the average number of carbon atoms in the alkyl group is from 11 to 14.

8. The process according to claim 7, wherein said anionic surfactant is the acid form of linear alkylbenzenesulfonate (HLAS) in which the average number of carbon atoms in the alkyl group is from 11 to 14, and wherein HLAS comprises at least about 20% by weight of HLAS of 2-phenyl isomer.

9. The process according to claim 1, wherein in step b), the anionic surfactant is present at a level of about 5% to about 50% by weight of the external structuring system.

10. The process according to claim 1, wherein in step b), the premix is neutralised to a pH of from about 7.0 to about 7.6, by adding a pH adjusting agent or a mixture thereof.

11. The process according to claim 10, wherein the pH adjusting agent is selected from group consisting of monoethanolamine, diethanolamine, triethanolamine, sodium hydroxide and mixtures thereof, most preferably pH adjusting agent is monoethanolamine.

12. The process according to claim 11, wherein the pH adjusting agent is monoethanolamine.

13. The process according to 10, wherein said pH adjusting agent is used at level from about 2% to about 10% by weight of the external structuring system.

14. An external structuring system comprising
a) from about 2% to about 10% by weight of the external structuring system of acidified structuring agent, wherein the acidified structuring agent comprises a non-polymeric, crystalline, hydroxyl-containing structuring agent and an acid;
b) from about 5% to about 50% by weight of the external structuring system of an anionic surfactant or a mixture thereof; and
c) water.

15. The external structuring system according to claim 14, wherein the acid is selected from the group consisting of arachidic acid, arachidonic acid, behenic acid, cerotic acid, eicosapentaenoic acid, elaidic acid, erucic acid, lauric acid, linoleic acid, linolenic acid, myristic acid, myristoleic acid, oleic acid, palmitic acid, palmitoleic acid, sapienic acid, stearic acid, vaccenic acid and mixtures thereof.

16. The external structuring system according to claim 14, wherein the structuring agent and acid are present in a weight ratio of from about 98:2 to about 75:25.

17. A liquid laundry detergent composition comprising the external structuring system according to claim 14, and a detersive surfactant.
